(19) United States
(12) Patent Application Publication
(10) Pub. No.: US 2014/0010568 A1
(43) Pub. Date: Jan. 9, 2014

(54) IMAGE FORMING APPARATUS

(71) Applicant: Canon Kabushiki Kaisha, Tokyo (JP)

(72) Inventors: Toshihiko Takayama, Kawasaki-shi (JP); Kenichi Iida, Tokyo (JP); Yusuke Shimizu, Yokohama-shi (JP)

(21) Appl. No.: 13/934,991

(22) Filed: Jul. 3, 2013

(30) Foreign Application Priority Data
Jul. 9, 2012 (JP) 2012-153591

(51) Int. Cl. G03G 15/16

(52) U.S. Cl. CPC G03G 21/10
USPC 399/101

(57) ABSTRACT

The image forming apparatus sets a polarity of a voltage applied to the brush to an opposite polarity to the polarity of the voltage applied to the brush when the residual toner of the secondary transfer on an intermediate transferring belt passes through the position opposed to the brush, and on the other hand, the polarity of the voltage applied to a primary transfer roller is set to the opposite polarity to the polarity of the voltage applied to the primary transfer roller when a toner image is primarily transferred onto the intermediate transferring belt in the primary transfer portion (N1), for allowing an image forming operation to be suspended less frequently in a case of executing a cleaning mode for eliminating the residual toner of the secondary transfer from the brush member.

### BACKGROUND OF THE INVENTION

1. Field of the Invention

The present invention relates to an image forming apparatus, such as a copier or a printer, having a function of forming an image on a recording material such as a sheet.

2. Description of the Related Art

Up to now, as an image forming apparatus such as a copier or a laser beam printer, there is known an in-line color image forming apparatus having a structure in which multiple image bearing members are arrayed in a rotational direction of an intermediate transferring member.

In a primary transfer step, the image forming apparatus transfers a toner image formed on a surface of a photosensitive drum serving as the image bearing member onto the intermediate transferring member. After that, the primary transfer step is repeatedly executed for toner images in multiple colors, to thereby form the toner images in multiple colors on a surface of the intermediate transferring member. Subsequently, in a secondary transfer step, the toner images in multiple colors formed on the surface of the intermediate transferring member are transferred collectively onto a surface of a recording material. After that, the toner images collectively transferred onto the recording material are fixed permanently by a fixing device, to thereby form a full-color image.

Japanese Patent Application Laid-Open No. 2009-205012 proposes a method that uses a conductive brush member and a conductive roller member as a method of clearing a residual toner on the intermediate transferring member after the secondary transfer step (hereinafter referred to as “residual toner of secondary transfer”). Specifically, a voltage is applied to the brush member disposed on an upstream side, to thereby charge the surface of the intermediate transferring member while spreading thereon the residual toner of the secondary transfer on the intermediate transferring member. In addition, the roller member disposed downstream thereof is caused to charge the residual toner of the secondary transfer that has passed through the brush member.

In this manner, the residual toner of the secondary transfer on the intermediate transferring member is brought into a uniformly-charged state. The uniformly-charged residual toner of the secondary transfer is reversely transferred onto the photosensitive drum in the primary transfer step and collected by a cleaning device for the photosensitive drum.

The conductive brush member has chargeability lowered when the residual toner of the secondary transfer adheres thereto and accumulates at a tip end of a brush. When the chargeability of the conductive brush member is lowered, the residual toner of the secondary transfer is not sufficiently charged, and there is a problem in that the residual toner of the secondary transfer is not reversely transferred onto the photosensitive drum from the intermediate transferring member.

Therefore, it is necessary to execute a cleaning mode for eliminating the residual toner of the secondary transfer from the brush member.

However, when the cleaning mode is executed, an image forming operation needs to be suspended, and there is a problem in that a long period of time is required until continuous printing is finished.

### SUMMARY OF THE INVENTION

It is an object of the present invention to provide an image forming apparatus that allows an image forming operation to be suspended less frequently in a case of executing a cleaning mode for eliminating a residual toner of secondary transfer from a brush member.

It is another object of the present invention to provide an image forming apparatus, including: an image bearing member for bearing a toner image; an intermediate transferring member formed into an endless shape and provided in a rotatable manner, the intermediate transferring member being configured to secondarily transfer the toner image, which is primarily transferred from the image bearing member in a primary transfer portion, onto a recording material in a secondary transfer portion; a brush member brought into contact with the intermediate transferring member at a position downstream of the secondary transfer portion in a rotational direction of the intermediate transferring member and upstream of the primary transfer portion, the brush member being configured to charge a residual toner remaining on the intermediate transferring member without being secondarily transferred onto the recording material in the secondary transfer portion to an opposite polarity to a normal charge polarity of a toner; a power supply portion for applying a voltage to the brush member; and a control device for controlling the power supply portion, the control device being capable of executing a cleaning mode for collecting, from the brush member, the residual toner adhering to the brush member. The control device causes, when the cleaning mode is executed in a case where image formation is continuously performed for multiple recording materials, the residual toner to migrate from the brush member to an area on a surface of the intermediate transferring member which is located between the residual toner remaining on the intermediate transferring member without being secondarily transferred onto a leading recording material and the residual toner remaining on the intermediate transferring member without being secondarily transferred onto a following recording material.

Further features of the present invention will become apparent from the following description of exemplary embodiments with reference to the attached drawings.

### BRIEF DESCRIPTION OF THE DRAWINGS

FIG. 1 is a sectional view illustrating a schematic structure of an image forming apparatus according to an embodiment of the present invention.

FIG. 2 is a schematic sectional view illustrating distances and speeds involved in respective components of an image forming apparatus according to Embodiment 1 of the present invention.

FIG. 3 is a timing chart of print parts and non-print parts in a unit and respective portions according to Embodiment 1.

FIG. 4 is a timing chart illustrating brush cleaning and collection according to Embodiment 1.

FIG. 5 is a view illustrating timings to switch an applied voltage in the brush cleaning according to Embodiment 1.

FIG. 6 is a table showing comparison results on whether or not a cleaning defection is caused according to respective embodiments of the present invention and a conventional type.

FIG. 7 is a timing chart illustrating brush cleaning and collection according to Embodiment 2 of the present invention.

FIG. 8 is a timing chart illustrating brush cleaning and collection according to Embodiment 3 of the present invention.

FIG. 9 is a timing chart illustrating brush cleaning and collection according to Embodiment 4 of the present invention.

### DESCRIPTION OF THE EMBODIMENTS

Embodiments of the present invention are illustratively described below in detail with reference to the accompanying drawings. However, dimensions, materials, and shapes of components described in the embodiments, a relative arrangement thereof, and other such factors may be appropriately changed depending on structures of devices to which the invention is applied or various conditions, and are not intended to limit the scope of the present invention to the following embodiments.

### Embodiment 1

(1) Overall Structure of Image Forming Apparatus

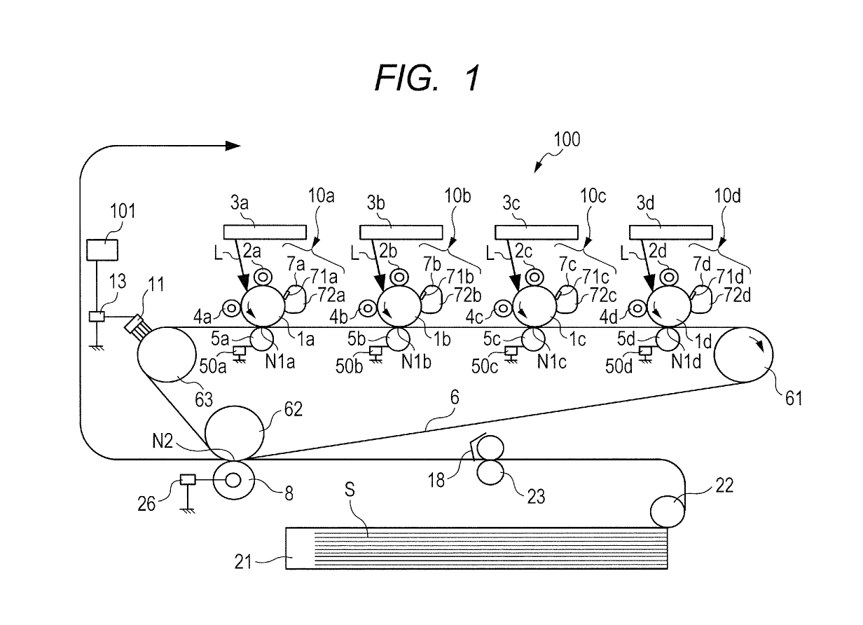

FIG. 1 is a sectional view illustrating a schematic structure of an image forming apparatus according to an embodiment of the present invention.

An image forming apparatus 100 according to this embodiment is an electrophotographic full-color laser beam printer. Further, the image forming apparatus 100 according to this embodiment is an image forming apparatus of a tandem type using an intermediate transferring system. In other words, in the image forming apparatus 100 according to this embodiment, toner images in respective colors formed based on image information decomposed into multiple color components are primarily transferred onto an intermediate transferring member while being overlaid on one another, and then secondarily transferred collectively onto a sheet serving as a recording material, to thereby obtain a recorded image.

The image forming apparatus 100 according to this embodiment includes first, second, third, and fourth stations (image forming stations) 10a, 10b, 10c, and 10d as multiple image forming units. The first to fourth stations 10a to 10d are arranged (arrayed) in a line in the stated order from a most upstream side along a moving direction of a surface of an intermediate transferring belt 6 serving as the intermediate transferring member capable of rotational movement (rotational direction of the intermediate transferring belt 6). In this embodiment, the first to fourth stations 10a to 10d are used to form toner images in colors of yellow (Y), magenta (M), cyan (C), and black (K), respectively.

Note that, in this embodiment, the structures and operations of the respective stations have many parts in common. Therefore, unless particular distinction is required, the description is hereinafter made collectively by omitting suffixes a, b, c, and d that are given to the reference symbols within the figures in order to indicate the colors of the respective components.

The image forming apparatus 100 includes a drum-type electrophotographic photosensitive member (hereinafter referred to as “photosensitive drum”) 1 serving as an image bearing member inside each station. The photosensitive drum 1 is rotationally driven by a driving device (not shown) in a direction indicated by an arrow illustrated in FIG. 1 (counterclockwise in FIG. 1). The photosensitive drum 1 has a surface charged uniformly by a charging roller (primary charging device) 2 serving as a charging device. Subsequently, laser light L based on the image information is radiated to the photosensitive drum 1 by an exposure device 3, and an electrostatic latent image (electrostatic image) is formed on the photosensitive drum 1 (on the image bearing member).

When the surface of the photosensitive drum 1 further moves in the direction indicated by the arrow illustrated in FIG. 1, the electrostatic latent image formed on the photosensitive drum 1 based on the image information is visualized as the toner image by a developing device 4. In this embodiment, the developing device 4 develops the electrostatic latent image on the photosensitive drum 1 by using toner in a reversal development system. In other words, the developing device 4 performs development by causing the toner charged to the same polarity as a charge polarity (in this embodiment, negative polarity) of the photosensitive arum 1 to adhere to an image part (exposure part) having an electric potential attenuated by exposure, which is a part of the uniformly-charged surface of the photosensitive drum 1.

The intermediate transferring belt 6 is disposed on a downstream side of a position for the development in the moving direction of the surface of the photosensitive drum 1, which is indicated by the arrow illustrated in FIG. 1, so as to be brought into contact with the photosensitive drum 1.

The intermediate transferring belt 6 is a cylindrical rotatable film having an endless belt shape (endless shape), which is stretched around three rollers of a drive roller 61, a secondary transfer opposing roller 62, and a tension roller 63 serving as multiple support members. By rotationally driving the drive roller 61 in a direction indicated by an arrow illustrated in FIG. 1 (clockwise in FIG. 1), the intermediate transferring belt 6 moves (rotates) in the direction indicated by the arrow illustrated in FIG. 1 (clockwise in FIG. 1) at substantially the same speed (peripheral speed) as a moving speed (peripheral speed) of the surface of the photosensitive drum 1.

A primary transfer roller 5 being a primary transfer member (transfer member) serving as a primary transfer device is disposed in a position opposed to the photosensitive drum 1 across the intermediate transferring belt 6. The primary transfer roller 5 presses the intermediate transferring belt 6 against the photosensitive drum 1, and forms a primary transfer portion (primary transfer nip portion) N1 in which the photosensitive drum 1 and the intermediate transferring belt 6 are brought into contact with each other. The intermediate transferring belt 6 stretched around the drive roller 61, the secondary transfer opposing roller 62 and the tension roller 63, multiple primary transfer rollers 5a to 5d, and the like constitute an intermediate transferring unit.

In accordance with rotation of the photosensitive drum 1 and the intermediate transferring belt 6, the toner image formed on the photosensitive drum 1 is transferred (primarily transferred) onto an outer peripheral surface of the intermediate transferring belt 6 by action of the primary transfer roller 5. At this time, a primary transfer voltage (applied voltage for primary transfer) having an opposite polarity (in this embodiment, positive polarity) to a normal charge polarity of the toner is applied to the primary transfer roller 5 from a primary transfer power supply portion 50 serving as a primary transfer voltage feeding device. Through this application, in a primary transfer step, an electric field having a direction that causes the toner charged to the normal charge polarity to move from the photosensitive drum 1 side to the intermediate transferring belt 6 side is formed in the primary transfer portion N1.

The toner remaining on the photosensitive drum 1 without being transferred onto the intermediate transferring belt 6 in the primary transfer step is cleared by a cleaner 7 serving as a cleaning device (collecting member) for the photosensitive member. The cleaner 7 includes, as the cleaning member, a cleaning blade 71 formed of a plate-like elastic body and disposed so as to be brought into contact with the surface of the photosensitive drum 1. Further, the cleaner 7 includes a collection toner container 72 for collecting the toner cleared from the surface of the photosensitive drum 1 by the cleaning blade 71.

The respective steps of charging, exposure, development, and primary transfer as described above are performed for each of the colors of yellow, magenta, cyan, and black in the first to fourth stations 10a to 10d in order from the upstream in the moving direction of the surface of the intermediate transferring belt 6. Accordingly, toner images in multiple colors, for example, in a case of a full-color image, the toner images in the four colors of yellow, magenta, cyan, and black, are formed on the intermediate transferring belt 6 while being overlaid on one another.

A secondary transfer roller 8 being a secondary transfer member serving as a secondary transfer device is disposed in a position opposed to the secondary transfer opposing roller 62 across the intermediate transferring belt 6. The secondary transfer roller 8 is pressed against the secondary transfer opposing roller 62 through an intermediation of the intermediate transferring belt 6, and forms a secondary transfer portion (secondary transfer nip portion) N2 in which the intermediate transferring belt 6 and the secondary transfer roller 8 are brought into contact with each other.

The toner image on the intermediate transferring belt 6 is transferred (secondarily transferred) onto a sheet S by action of the secondary transfer roller 8. In other words, the sheet S received in a sheet feeding cassette 21 is sent out by a feed roller 22, and then fed to the secondary transfer portion N2, in which the intermediate transferring belt 6 and the secondary transfer roller 8 are brought into contact with each other, at a predetermined timing by a registration roller pair 23. Substantially simultaneously therewith, a secondary transfer voltage having the opposite polarity (in this embodiment, positive polarity) to the normal charge polarity of the toner is applied to the secondary transfer roller 8 by a secondary transfer power supply portion (not shown) serving as a secondary transfer voltage feeding device. Through this application, in a secondary transfer step, an electric field having a direction that causes the toner charged to the normal charge polarity to move from the intermediate transferring belt 6 side to the sheet S side is formed in the secondary transfer portion N2.

Here, a residual toner of secondary transfer (residual toner) remaining on the intermediate transferring belt 6 without being transferred onto the sheet S in the secondary transfer step is evenly spread and is caused to carry an electric charge by a cleaning brush (brush member; hereinafter referred to as “brush”) 11 serving as a charging member. The brush 11 is connected to a first cleaning power supply portion (high voltage power supply portion) 13 for applying a direct current voltage, which serves as a first cleaning voltage feeding device. The brush 11 and the first cleaning power supply portion 13 constitute an intermediate transferring member cleaning device.

The brush 11 is disposed downstream of the secondary transfer portion N2 in the moving direction of the surface of the intermediate transferring belt 6 (rotational direction of the intermediate transferring belt 6) and upstream of a primary transfer portion N1a of the first station 10a. Accordingly, in this embodiment, the brush 11 causes the residual toner of the secondary transfer remaining on the intermediate transferring belt 6 after the secondary transfer to be charged upstream of the primary transfer portion N1a of the first station 10a.

Then, in this embodiment, the residual toner of the secondary transfer caused to carry an electric charge by the brush 11 is reversely transferred onto a photosensitive drum 1a of the first station 10a. Then, the residual toner of the secondary transfer, which is reversely transferred from the intermediate transferring belt 6 and adheres to the photosensitive drum 1a, is cleared from the surface of the photosensitive drum 1a and collected by a cleaner 7a.

Note that, a part of the residual toner of the secondary transfer adheres to the brush 11 when being charged by the brush 11. In order to collect the adhering toner from the brush 11, it is necessary to execute a cleaning mode (charging cleaning mode), and the cleaning mode is described later.

An interval between primary transfer images during continuous printing hereinafter represents the following area in a case where the image formation is continuously performed on multiple sheets in one job. That is, the area is an area on the intermediate transferring belt 6 which is located between the toner image primarily transferred onto the intermediate transferring belt 6 in order to form the image on a leading recording material and the toner image primarily transferred onto the intermediate transferring belt 6 in order to form the image on a following recording material. Further, an interval between the residual toners of the secondary transfer during the continuous printing represents the following area in the case where the image formation is continuously performed on multiple sheets. That is, the area is an area on the intermediate transferring belt 6 which is located between the residual toner of the secondary transfer remaining on the intermediate transferring belt 6 without being secondarily transferred onto the leading recording material and the residual toner of the secondary transfer remaining on the intermediate transferring belt 6 without being secondarily transferred onto the following recording material. Further, a timing at which the interval between the residual toners of the secondary transfer during the continuous printing coincides with the interval between the primary transfer images is the following timing. That is, the timing is a timing after the toner image is primarily transferred onto the intermediate transferring belt 6 in order to form the image on a leading sheet and before the toner image is primarily transferred onto the intermediate transferring belt 6 in order to form the image on a following sheet.

In this embodiment, the toner is charged to the negative polarity by the developing device 4, and a voltage having the positive polarity is applied to each of the primary transfer roller 5 and the secondary transfer roller 8 from nigh voltage power supplies corresponding thereto, to thereby perform the image formation. Therefore, under influence of the voltage having the positive polarity applied to the secondary transfer roller 8, both the positive and negative polarities coexist in the residual toner of the secondary transfer remaining on the intermediate transferring belt 6 after the secondary transfer step. Further, under influence of irregularities or the like of a surface of the sheet S, the residual toner of the secondary transfer remains on the intermediate transferring belt 6 locally in multiple layers.

Therefore, in this embodiment, first, the voltage having the opposite polarity to the normal charge polarity of the toner, in other words, the positive polarity in this embodiment is applied to the brush 11 from the first cleaning power supply portion 13.

Accordingly, the residual toner of the secondary transfer on the intermediate transferring belt 6 is charged to the positive polarity when passing through the brush 11. Further, at this time, the negative-polarity toner that has failed to be charged to the positive polarity is partially collected into the brush 11.

Further, the toner deposited on the intermediate transferring belt 6 in multiple layers is spread into substantially one layer when passing through the brash 11 due to a pressing force of the brush 11.

After that, the residual toner of the secondary transfer caused to carry an electric charge having an optimum positive polarity moves as the surface of the intermediate transferring belt 6 moves, and in this embodiment, is reversely transferred in the primary transfer portion N1a of the first station 10a, to thereby be collected onto the photosensitive drum 1a.

Note that, in this embodiment, the photosensitive drum 1, and the charging roller 2, the developing device 4, and the cleaner 7 serving as process devices that act upon the photosensitive drum 1 constitute an integral process cartridge that is removably mounted to an apparatus main body of the image forming apparatus 100.

(2) Primary Transfer Roller 5

Used as the primary transfer roller 5 is an elastic roller having a volume resistivity of 1×10⁵ to 1×10⁹ Ωcm and a rubber hardness of 30° (Asker C hardness meter). The primary transfer roller 5 is pressed against the photosensitive drum 1 through an intermediation of the intermediate transferring belt 6 with a total pressure of approximately 9.8 N. Further, the primary transfer roller 5 is rotated by following the rotation of the intermediate transferring belt 6. In addition, a voltage of −2.0 to 3.5 kV can be applied to the primary transfer roller 5 from the primary transfer power supply portion (high voltage power supply portion) 50.

(3) Intermediate Transferring Belt 6

Used as the intermediate transferring belt 6 is a poly(vinylidene fluoride) (PVDF) film having a thickness of 100 μm and having a volume resistivity adjusted to 1×10¹¹ Ωcm by mixing a conductive agent. Further, the intermediate transferring belt 6 is stretched around three shafts of the drive roller 61, the secondary transfer opposing roller 62, and the tension roller 63, and is given a tension having a total pressure of approximately 60 N by the tension roller 63.

(4) Secondary Transfer Roller 8

Used as the secondary transfer roller 8 is an elastic roller having a volume resistivity of 1×10⁵ to 1×10⁹ Ωcm and a rubber hardness of 30° (Asker C hardness meter). Further, the secondary transfer roller 8 is pressed against the secondary transfer opposing roller 62 through an intermediation of the intermediate transferring belt 6 with a total pressure of approximately 39.2 N. Further, the secondary transfer roller 8 is rotated by following the rotation of the intermediate transferring belt 6. In addition, a voltage of −2.0 to 4.0 kV can be applied to the secondary transfer roller 8 from the secondary transfer power supply portion (high voltage power supply portion; not shown).

(5) Brush 11

Used as the brush 11 is a brush provided with multiple fibers made of nylon having a conductivity of 1×10⁶ to 1×10⁹ Ωcm structured so that the multiple fibers become substantially dense. In this embodiment, the brush 11 is disposed fixedly. The brush 11 has a tip end position set so as to have an entering amount of 1.0 mm with respect to the surface of the intermediate transferring belt 6. The brush 11 is pressurized against the tension roller 63 through an intermediation of the intermediate transferring belt 6. The brush 11 has substantially the same length in the longitudinal direction (direction intersecting the moving direction of the surface of the intermediate transferring belt 6) as a width in the same direction of an image-formation-enabled area on the surface of the intermediate transferring belt 6.

In this manner, the brush 11 located on an upstream side in the moving direction of the surface of the intermediate transferring belt 6 rubs the surface of the intermediate transferring belt 6 as the intermediate transferring belt 6 moves. Then, a voltage of −2.0 to +2.0 kV can be applied to the brush 11 from the first cleaning power supply portion 13.

In this embodiment, the brush 11 has a support portion for supporting the multiple fibers, which is disposed fixedly so that tip ends of the multiple fibers keep rubbing the surface of the intermediate transferring belt 6. With such a structure, the brush 11 can charge the residual toner of the secondary transfer in multiple layers while spreading the residual toner of the secondary transfer on the intermediate transferring belt 6.

(6) Sheet Trailing Edge Detection Device

In this embodiment, a shutter member 18 serving as a swing member is used in a registration portion as a detection device for detecting a sheet. The shatter member 18 is provided in a stand-by position on a sheet conveying path swingable, and provided so as to correct skew feeding of the sheet S by being brought into contact with the conveyed sheet S and cause the sheet S to pass through the shutter member 18 by moving from the stand-by position due to the contact with the sheet S.

That is, the shutter member 18 is structured so as to allow the sheet S conveyed by the registration roller pair 23 to pass through the shutter member 18 while causing the shutter member 18 to pivot (rotate or swing). The shutter member 18 is further structured so that, even when the sheet S is fed in a skewed manner, the sheet S reaches the secondary transfer portion N2 with the skew feeding corrected by thus passing through the shutter member 18 while causing the shutter member 18 to pivot.

The sheet S that has reached the secondary transfer portion N2 is conveyed by the intermediate transferring belt 6 driven to rotate, and a trailing edge of the sheet S passes through the shutter member 13. The shutter member 18 returns to the stand-by position after the passing of the sheet S, and hence a photosensor or the like is used to detect the shutter member 18 returning to the stand-by position, to thereby be able to detect a trailing edge of the recording material. This timing is hereinafter set as a detection timing of a sheet trailing edge.

(7) Cleaning Mode of Charging Member (brush 11)

Next, the cleaning mode for collecting the adhering residual toner of the secondary transfer from the brush 11 is described in detail.

When the cleaning mode is executed, removal of a primary collection toner from the brush 11 is performed.

The removal of the primary collection toner from the brush 11 in the cleaning mode represents that the primary collection toner (deposited toner) accumulated in the brush 11 is migrated from the brush 11 to the intermediate transferring belt 6. The primary collection toner migrated to the intermediate transferring belt 6 by performing the removal of the primary collection toner from the brush 11 is migrated in the primary transfer portion from the intermediate transferring belt 6 to the photosensitive drum 1, and is then cleared from the photosensitive drum 1a and collected by the cleaner 7a. The cleaning mode according to this embodiment has been described so far. In this embodiment, the cleaning mode is executed for the interval between the primary transfer images during the continuous printing.

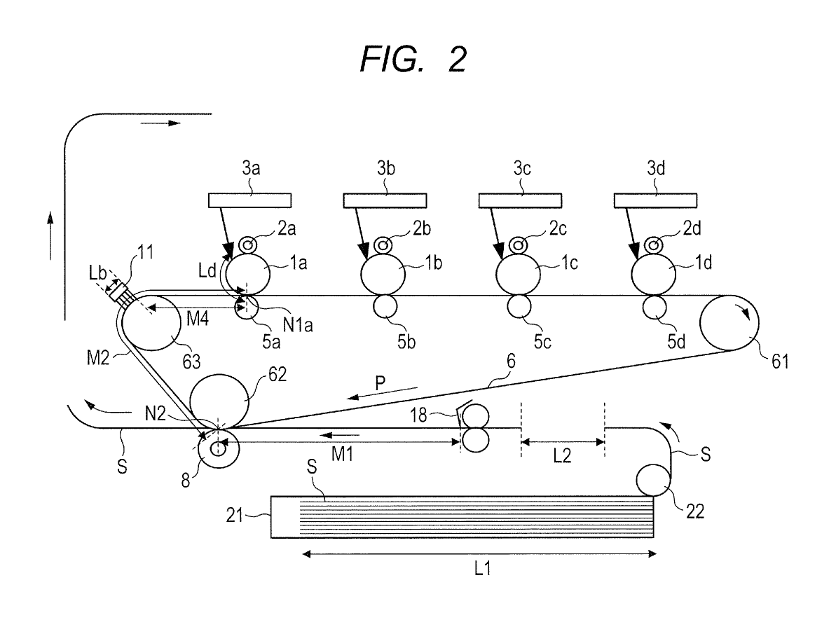

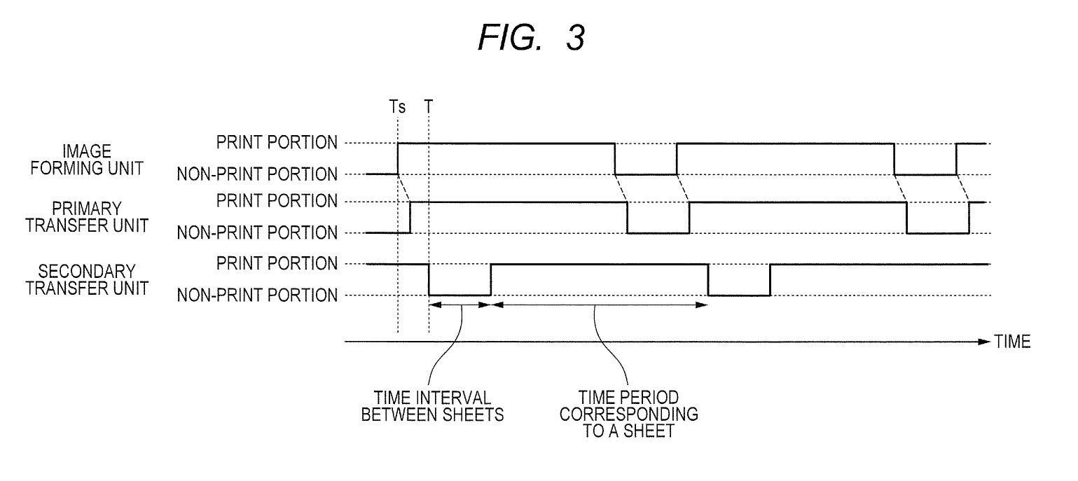

FIG. 2 is a schematic sectional view illustrating distances and speeds involved in respective components of the image forming apparatus 100. FIG. 3 is a timing chart of a print part (print area) and a non-print part (non-print area) in the image forming unit, the primary transfer portion, and the secondary transfer portion during the continuous printing according to this embodiment. Here, the “image forming unit” illustrated in FIG. 3 indicates whether or not the print part is formed (the toner image is formed) on the photosensitive drum 1 by the exposure device 3 radiating the laser light L to the photosensitive drum 1 (image formation timing). Further, the “primary transfer portion” and the “secondary transfer portion” illustrated in FIG. 3 indicate whether or not the print part (part in which the toner image is formed) exists in each of the primary transfer portion N1 and the secondary transfer portion N2 (whether or not the print part is passing through each of the primary transfer portion N1 and the secondary transfer portion N2). This in turn can indicate whether or not a transfer step is being performed in each of the primary transfer portion N1 and the secondary transfer portion N2.

As illustrated in FIGS. 2 and 3, a sheet length (length in the sheet conveying direction in which the sheet is conveyed to the secondary transfer portion N2) is hereinafter set as L1 (mm), and an inter-sheet gap (length in the sheet conveying direction between the leading sheet and the following sheet) is hereinafter set as L2 (mm). Further, a distance from the shutter member 18 to the secondary transfer portion N2 is set as M1 (mm), and a distance from the secondary transfer portion N2 to the primary transfer portion N1a of the first station 10a is set as M2 (mm). Further, a distance from a downstream end of the brush 11 in the moving direction of the surface of the intermediate transferring belt 6 to the primary transfer portion N1a of the first station 10a is set as M4 (mm), a contact width between the intermediate transferring belt 6 and the brush 11 is set as Lb (mm), and a process speed is set as P (mm/sec). Further, a time instant at which the sheet trailing edge finishes passing through the shutter member 18 during the continuous printing is set as T, a time instant at which the image formation (drum exposure) is started for the image that is being subjected to the image formation at the time instant T is set as Ts, and a distance from an exposure position to the primary transfer portion N1a is set as Ld (mm). The time instant T is a timing at which the detection device detects the sheet, and is a time instant (time point) serving as a reference of time described below.

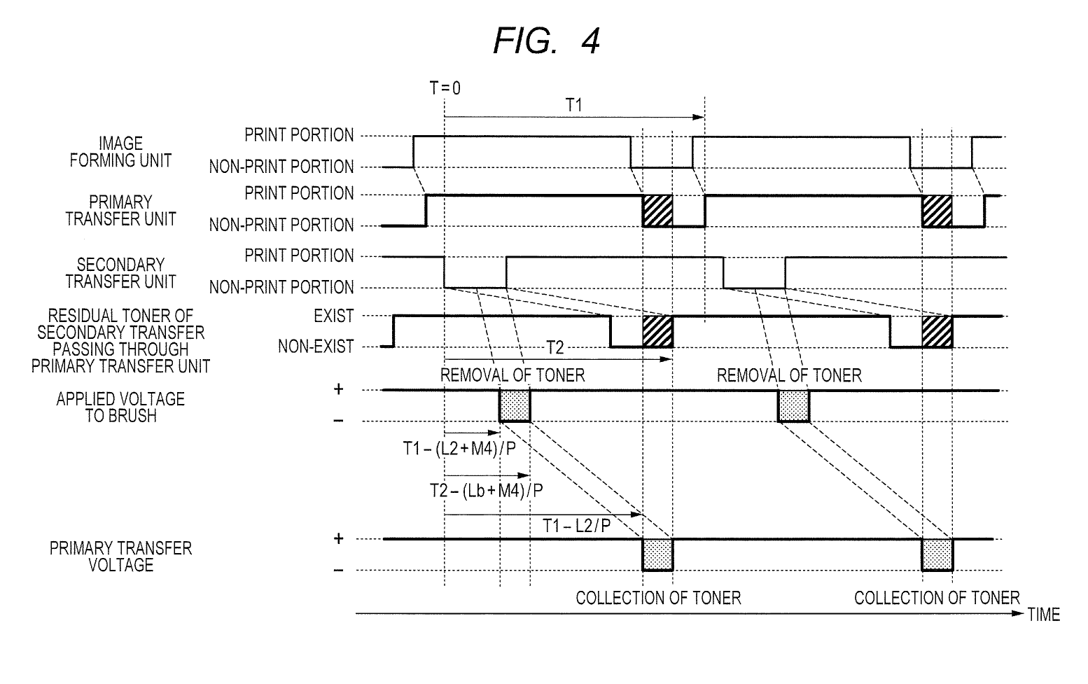

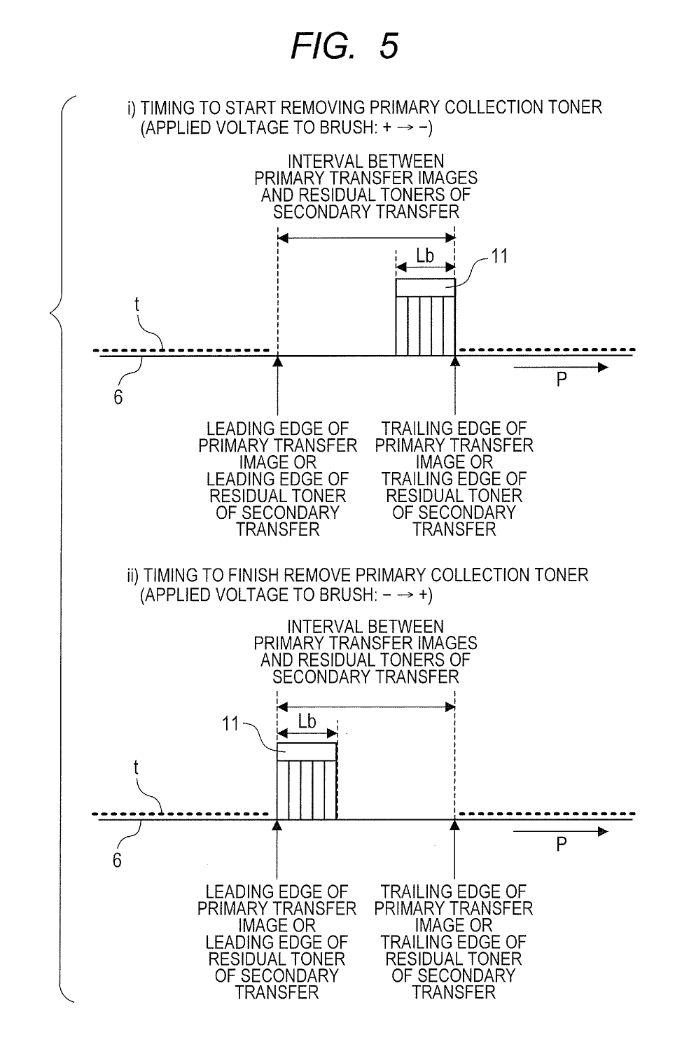

FIG. 4 is a timing chart illustrating brush cleaning and collection in the primary transfer portion according to this embodiment. The image forming unit, the primary transfer portion, and the secondary transfer portion illustrated in FIG. 4 are the same as those of FIG. 3. In addition, FIG. 4 illustrates the timing chart of existence/non-existence of the residual toner of the secondary transfer passing through the primary transfer portion N1, the voltage applied to the brush 11 (applied voltage to the brush), and the primary transfer voltage applied to the primary transfer roller 5 (applied voltage to the primary transfer portion). FIG. 5 is a schematic sectional view illustrating timings to switch an applied voltage in the brush cleaning according to this embodiment. FIG. 5 illustrates the residual toner of the secondary transfer indicated by t.

As illustrated in FIG. 4, the time period after the time instant T until a leading edge of the subsequent toner image within the first station 10a reaches the primary transfer portion N1a is set as T1, and the time period after the time instant T until a leading edge of the residual toner of the secondary transfer of the sheet subsequent to the sheet whose trailing edge finishes passing through the secondary transfer portion N2 at the time instant T enters the primary transfer portion N1a is set as T2. Then, the time period 11 and the time period T2 can be expressed as follows,

T1=(L1+L2+Ld)/P−(T−Ts)

T2=(L2+M1+M2)/P

Here, T1 may be paraphrased as the time period after the sheet is detected until the primary transfer portion N1a is reached by the toner image to be transferred onto a sheet following the sheet onto which the toner image, which is primarily transferred when the sheet is detected, is transferred. Further, T2 may be paraphrased as the time period after the sheet is detected until the primary transfer portion N1a is reached by the residual toner of the secondary transfer remaining on the intermediate transferring belt 6 without being secondarily transferred onto the sheet following to the detected sheet.

If T1 and 12 satisfy:

|T1−T2|<L2/P,

an inter-sheet gap area in which the interval between the images in the primary transfer step and the interval between the residual toners of the secondary transfer overlap each other is secured (hatched parts in FIG. 4). Further, as illustrated in FIG. 5, in order to discharge the primary collection toner from the brush 11, the overlapping area needs to have a width larger than at least the contact width (brush width Lb) between the charging member and the intermediate transferring belt 6.

Therefore, if the following condition is satisfied at the time instant T at which the trailing edge of the sheet S passes through the shutter member 18, it is determined that the primary collection toner accumulated in the brush can be discharged onto the overlapping area. Here, a minimum overlap width necessary for the removal of the primary collection toner from the brush 11 is set twice as a brush width (2Lb).

That is, the condition is:

|T1−T2|<(L2−2LP)/P.

This expression can also be expressed as:

|T1−T2|<T3−T1.

In the expression, the time period T3 is a time period after the trailing edge of the leading sheet passes through the secondary transfer portion N2 until the following sheet reaches the secondary transfer portion N2, and the time period T4 is a time period required for one point on the outer peripheral surface of the intermediate transferring belt 6 to pass through a position opposed to the brush 11.

Now, a cleaning operation of the brush 11 and a discharged toner collection operation in the primary transfer portion N1 are described in detail. Here, the discharged toner represents the primary collection toner discharged from the brush 11. The cleaning operation and the discharged toner collection operation in the primary transfer portion N1 that are performed during the continuous printing according to this embodiment are executed by a control unit 101 (control device) of the image forming apparatus 100. The control unit 101 is a controller that can control voltages applied to the brush member and the primary transfer member. Specifically, as illustrated in FIG. 1, the control unit 101 can control the first cleaning power supply portion 13 for applying the voltage to the brush member 11.

Here, FIG. 4 illustrates a case where |T1−T2|<(L2−2Lb)/P and T1−T2>0.

If T1−T2>0, the applied voltage to the brush 11 is switched to the negative polarity after T1−(L2+M4)/P seconds have elapsed since the time instant T, and the removal of the primary collection toner charged to the negative polarity is started. The primary collection toner charged to the negative polarity can be discharged from the brush 11 by switching the applied voltage to the brush 11 to the negative polarity being the opposite polarity. Here, the opposite polarity represents the opposite polarity to the polarity of the voltage applied to the brush 11 when the residual toner of the secondary transfer on the intermediate transferring belt 6 passes through the position opposed to the brush 11.

Then, the removal is finished by switching to the positive polarity T2−(Lb+M4)/P seconds after the time instant T (“removal of toner” illustrated in FIG. 4). Here, (M4/P) corresponds to the time period after one point on the outer peripheral surface of the intermediate transferring belt 6 passes through the position opposed to the brush 11 until the primary transfer portion N1a is reached thereby.

Subsequently, T1−L2/P seconds after the time instant T, the primary transfer voltage of the first station 10a is switched to the negative polarity to start collecting the negative-polarity toner discharged onto the intermediate transferring belt 6 through reverse transfer, and T2 seconds after the time instant T, the primary transfer voltage is switched to the positive polarity (“collection of toner” illustrated in FIG. 4). By thus setting the primary transfer voltage to the opposite polarity to the polarity of the voltage applied when the toner image is primarily transferred onto the intermediate transferring belt 6 in the primary transfer portion N1a, the primary collection toner discharged from the brush 11 can be reversely transferred onto the photosensitive drum 1a and collected by the cleaner 7a.

On the other hand, if T1−T2<0, the applied voltage to the brush 11 is switched to the negative polarity after T2−(L2+M4)/P seconds have elapsed since the time instant T, and the removal of the primary collection toner charged to the negative polarity is started. Then, the removal is finished by switching to the positive polarity T1−(Lb+M4)/P seconds after the time instant T.

Subsequently, T2−L2/P seconds after the time instant T, the primary transfer voltage of the first station 10a is switched to the negative polarity to start collecting the negative-polarity toner discharged onto the intermediate transferring belt 6 through the reverse transfer, and T1 seconds after the time instant T, the primary transfer voltage is switched to the positive polarity.

In this embodiment, it is assumed that L1=297 mm, L2=30 mm, M1=40 mm, M2=80 mm, M4=60 mm, Lb=5 mm, P=137 mm/sec, and Ld=38 mm. In this case, 0≦T−Ts≦(L1+L2)/P≈2.39, and hence a range of T1−T2 that can be assumed in a case where a perimeter of the intermediate transferring belt 6 is not defined is −1.30≦T1−T2≦1.57. The condition for the overlapping of the inter-sheet gaps within this range is |T1−T2|<(L2−2Lb)/P≈0.15 seconds.

If T1−T2>0, that is, if 1.42<T−Ts<1.57, a timing (T1−(L2+M4)/P) to start removing the primary collection toner is 0.44 to 0.59 seconds after the time instant T. Then, a timing (T2−(Lb+M4)/P) to end the removal is 0.62 seconds after the time instant T.

Further, in the primary transfer step of the first station 10a, a timing (T1−L2/P) to start collecting the discharged toner is 0.88 to 1.03 seconds after the time instant T, and a timing (T2) to end collecting the discharged toner is 1.09 seconds after the time instant T.

If T1−T2<0, that is, if 1.57<T−Ts<1.72, a timing (T2−(L2+M4)/P) to start removing the primary collection toner is 0.44 seconds after the time instant T. Then, a timing (T1−(Lb+M4)/P) to end the removal is 0.47 to 0.62 seconds after the time instant T.

Further, in the primary transfer step of the first station 10a, a timing (T2−L2/P) to start collecting the discharged toner is 0.88 seconds after the time instant T, and a timing (T1) to end collecting the discharged toner is 0.94 to 1.09 seconds after the time instant T.

As described above, by securing the area being the interval between the primary transfer images and between the interval between the residual toners of the secondary transfer during the continuous printing, it is possible to perform the removal of the primary collection toner and discharged toner collection in the primary transfer step. By removing the primary collection toner during the continuous printing, it is possible to maintain primary collection performance of the brush or prolong life thereof, and there is no need to suspend the printing even in a continuous print job involving a large number of printing sheets, or it is possible to increase the number of continuous sheets before entering suspension compared to a conventional technology. Further, in this embodiment, the primary collection toner is discharged during the continuous printing, and an amount of the primary collection toner at a start of post-rotation is smaller than in a case where the primary collection toner is not discharged during the continuous printing, which can also shorten the time period required for the removal of the primary collection toner performed at a time of the post-rotation.

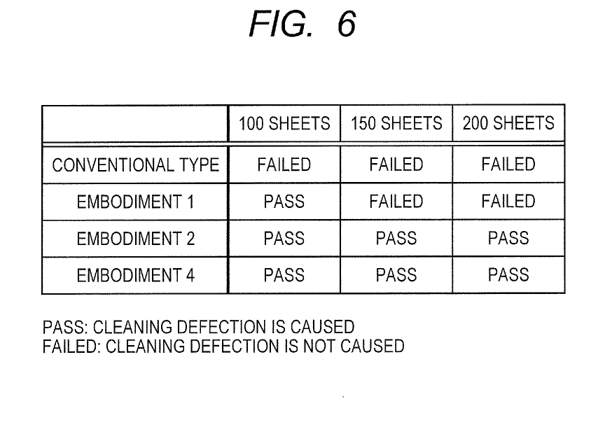

FIG. 6 shows comparison results on whether or not a cleaning defection is caused according to this embodiment and a conventional type.

FIG. 6 shows the number of sheets supplied when an image to be printed over an entire surface of the sheet in a single color at a density of 100% is continuously printed and results of an evaluation on whether or not a cleaning defection is caused. In this evaluation, the cleaning defection is caused with 100 sheets in the conventional type, but is not caused with 100 sheets in this embodiment, which confirms an effect of prolonging the life with regard to the cleaning defection.

Here, this embodiment is described by taking the image forming apparatus including the four image forming stations, but the number of image forming stations is not limited to four. That is, the image forming station may be one, or multiple image forming stations may be arrayed along the rotational direction of the intermediate transferring belt 6.

Further, such a structure as illustrated in FIG. 5 in which the tip end of the brush member 11 keeps contact with the intermediate transferring belt 6 can reduce the contact width (brush width Lb) compared to the overlapping area. For example, in a case where a fur brush that performs a rotational movement is used as the charging member, at least one rotation of the fur brush is necessary to complete the removal. That is, the fur brush has the contact width necessary for the removal larger than the brush member 11, and hence it is difficult to keep the contact width within the overlapping area.

### Embodiment 2

Next, Embodiment 2 of the present invention is described. Note that, an image forming apparatus applied in this embodiment has the same structure as that of Embodiment 1 of the present invention described above, and the same components as those of Embodiment 1 are denoted by the same reference symbols, and descriptions thereof are omitted.

This embodiment has a feature in that the image formation is performed in the primary transfer portion in a specific phase (area) of a rotational direction of an intermediate transferring belt during the continuous printing.

Accordingly, the interval between the primary transfer images and the interval between the residual toners of the secondary transfer are caused to coincide with each other during the continuous printing according to Embodiment 1, and the removal of the primary collection toner and the discharged toner collection in the primary transfer step are performed more efficiently.

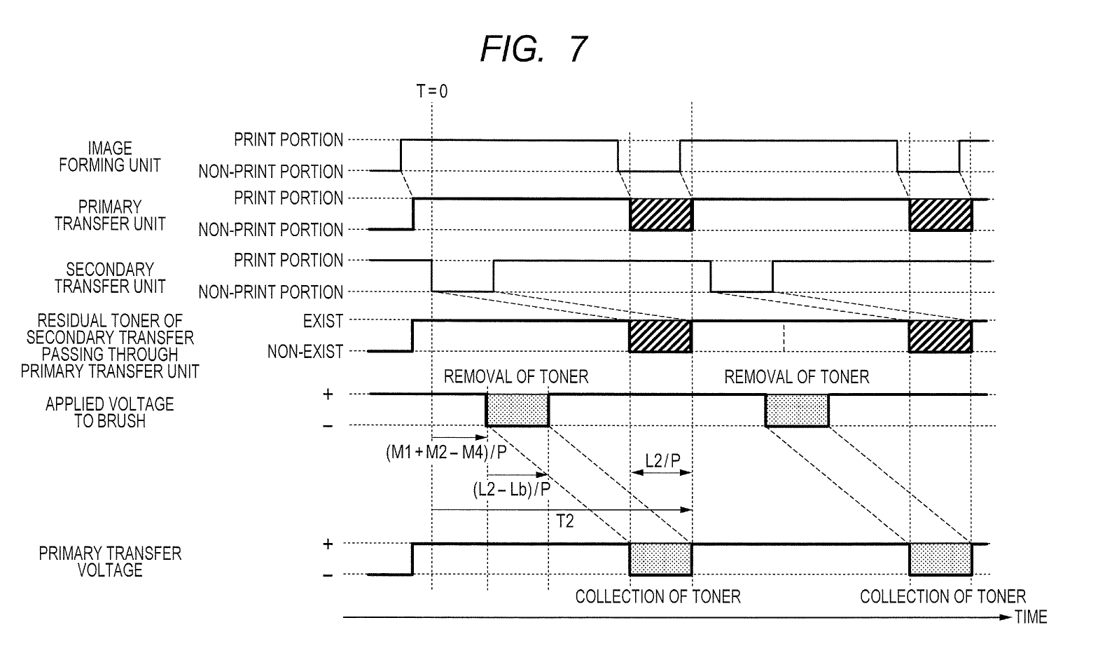

FIG. 7 is a timing chart illustrating brush cleaning and collection in the primary transfer portion according to this embodiment, and is a diagram corresponding to FIG. 4 relating to Embodiment 1.

In this embodiment, the perimeter of the intermediate transferring belt 6 is set to 712 mm, and the sheet length is set to 297 mm. In this case, images for two sheets can be printed in one round of the intermediate transferring belt, and hence the image formation performed in the primary transfer portion in the specific phase of the rotational direction of the intermediate transferring belt during the continuous printing is achieved by allocating the length of a non-image area to two inter-sheet gap areas. In this embodiment, the length of the non-image area is 712−2×297=118 mm. This embodiment is hereinafter described by assuming that the inter-sheet gap is 59 mm (=118 mm/2), but the inter-sheet gaps may be set alternately different from each other as long as a sum of the two inter-sheet gaps is 118 mm (for example, 48 mm→70 mm→48 mm→70 mm→ . . . ).

By thus setting the inter-sheet gap based on the perimeter of the intermediate transferring belt 6 and the sheet length, it is possible to transfer the image in the same phase every round in the rotational direction of the intermediate transferring belt during the continuous printing. That is, it is possible to cause an area for the primary transfer image and an area for the residual toner of the secondary transfer to constantly coincide with each other, that is, cause the interval between the primary transfer images and the interval between the residual toners of the secondary transfer to coincide with each other every round (hatched parts in FIG. 7). Therefore, without consideration of the condition for the overlapping between the interval between the primary transfer images and the interval between the residual toners of the secondary transfer, the primary collection toner may be discharged by detecting any one of the interval between the primary transfer images and the interval between the residual toners of the secondary transfer.

Now, a timing in a case of removing the primary collection toner onto the interval between the residual toners of the secondary transfer is described. Of T1 and T2, the case of using T2 is described below.

A timing to start removing the primary collection toner is (M1+M2−M4)/P seconds after the timing at which the trailing edge of a sheet being secondarily transferred finishes passing through the shutter member 18 based on a distance relationship among M1, M2, and M4. On the other hand, a timing to end the removal is (L2−Lb)/P seconds after a timing to start the removal. In this embodiment, by using the detection timing of the sheet trailing edge to assume a distance from the shutter member 18 to the secondary transfer portion N2 and a distance from the secondary transfer portion N2 to the brush 11, it is possible to accurately determine a timing to discharge the primary collection toner.

Next, a timing to collect the primary collection toner, which is discharged onto the intermediate transferring belt 6, in the primary transfer portion N1 is described.

A timing to start collecting the discharged toner in the primary transfer portion N1 is T2−L2/P seconds after the timing at which the trailing edge of the sheet being secondarily transferred finishes passing through the shutter member 18 by using T2 of Embodiment 1. On the other hand, a timing to end the collection is T2 seconds after the timing at which the trailing edge of the sheet being secondarily transferred finishes passing through the shutter member 18.

FIG. 6 shows results of performing in this embodiment the same evaluation regarding the cleaning defection as that of Embodiment 1. As shown in FIG. 6, in this embodiment, the cleaning defection is not caused even when 200 sheets are supplied, which confirms that this embodiment is more effective than Embodiment 1.

As described above, in this embodiment, by setting the inter-sheet gap based on the perimeter of the intermediate transferring belt 6 and the sheet length, the interval between the primary transfer images and the interval between the residual toners of the secondary transfer during the continuous printing are caused to coincide with each other. Accordingly, it is possible to increase a frequency of the removal of the primary collection toner and a time period for each removal, which can improve efficiency of the removal of the primary collection toner.

### Embodiment 3

Next, Embodiment 3 of the present invention is described. Note that, an image forming apparatus applied in this embodiment has the same structure as that of Embodiment 1 described above, and the same components as those of Embodiment 1 are denoted by the same reference symbols, and descriptions thereof are omitted.

This embodiment has a feature in that the removal of the primary collection toner onto the interval between the residual toners of the secondary transfer before the last image and the collection of the discharged toner in the primary transfer portion N1 are performed after the end of the primary transfer step of the last image of the continuous print job.

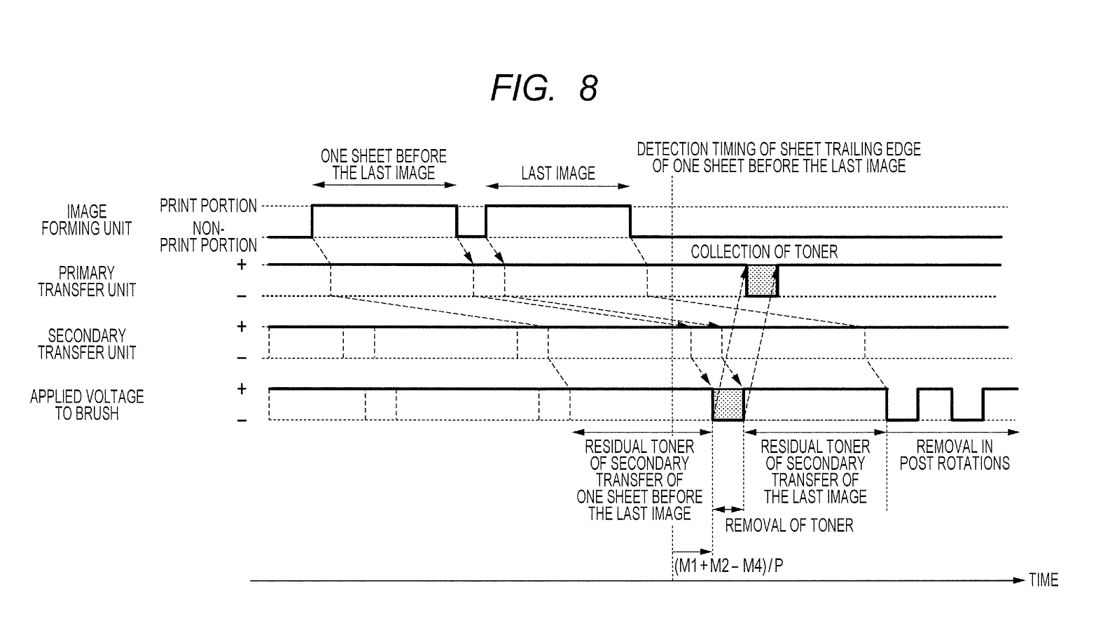

Here, the wording “after the end of the primary transfer step of the last image of the continuous print job” may be paraphrased as after the toner image used for performing the image formation for the last recording material among the multiple sheets continuously subjected to the image formation is primarily transferred onto the intermediate transferring belt 6 in the primary transfer portion N1. Further, it is assumed in this embodiment that a perimeter Li of the intermediate transferring belt 6 satisfies Li>L1+L2. Now, a sequence of this embodiment is described with reference to FIG. 8.

FIG. 8 is a timing chart illustrating brush cleaning and collection in the primary transfer portion according to this embodiment. FIG. 8 corresponds to FIG. 4 relating to Embodiment 1, but FIG. 8 illustrates the timing chart of the image formation timing in the image forming unit, the primary transfer voltage, the secondary transfer voltage, and the applied voltage to the brush at a time point starting with the second sheet from the last image in the image formation during the continuous printing.

The applied voltage in the primary transfer portion N1 during the image formation is the positive polarity, and the image transferred onto the intermediate transferring belt 6 reaches the secondary transfer portion N2 (Li−M2)/P seconds after a primary transfer timing of the first station 10a, and is transferred onto the sheet with the secondary transfer voltage having the positive polarity.

When the trailing edge of the residual toner of the secondary transfer of the second sheet from the last image reaches a downstream position of the brush 11 in the moving direction of the surface of the intermediate transferring belt 6, the primary collection toner is discharged by switching the applied voltage to the brush 11 from the positive polarity to the negative polarity. When the leading edge of the residual toner of the secondary transfer of the last image reaches an upstream position of the brush 11 in the moving direction of the surface of the intermediate transferring belt 6, the applied voltage in a brush portion is switched from the negative polarity to the positive polarity.

In this embodiment, the perimeter of the intermediate transferring belt 6 is Li>L1+L2, and hence the image formation in the primary transfer portion N1a is finished by the time when the toner discharged onto the interval between the residual toners of the secondary transfer for the second sheet from the last image and for the last image reaches the primary transfer portion N1a. Accordingly, it is possible to discharge the primary collection toner onto the interval between the residual toners of the secondary transfer without considering the overlapping area between the interval between the primary transfer images and the interval between the residual toners of the secondary transfer, which is described in Embodiment 1.

FIG. 3 illustrates a case where the discharged toner is collected by switching the applied voltage in the primary transfer portion N1a from the positive polarity to the negative polarity when the toner discharged onto the intermediate transferring belt 6 reaches the primary transfer portion N1a. However, in this method of collecting the discharged toner, the toner only needs to be collected by any one of the first to fourth stations, and hence the timing is not limited to the timing of the primary transfer voltage of this embodiment.

A timing to discharge the primary collection toner onto the interval between the residual toners of the secondary transfer according to this embodiment is the same as that of Embodiment 2. That is, the timing to start the removal is (M1+M2−M4)/P seconds after a timing at which the sheet trailing edge of the second sheet from the last image finishes passing through the shutter member 18, and the timing to end the removal is (L2−Lb)/P seconds after the timing to start the removal.

Further, in this embodiment, the case of removing the primary collection toner onto the interval between the residual toners of the secondary transfer for the second sheet from the last image and for the last image is described, but the present invention is not limited thereto. As long as the perimeter Li of the intermediate transferring belt 6, the sheet length L1, and the inter-sheet gap L2 satisfy a relationship of:

n(L1+L2)≦Li<(n+1)(L1+L2) (n: natural number),

the toner can be discharged onto the following interval between the residual toners of the secondary transfer. That is, as long as the above-mentioned relationship is satisfied, the toner can be discharged onto the interval between the residual toners of the secondary transfer corresponding to or subsequent to the interval between the residual toners of the secondary transfer of an (n+1)-th sheet from the last image and an n-th sheet from the last image. In this case, there exist n intervals between the residual toners of the secondary transfer, and hence the removal can be performed n times before the removal of the primary collection toner at the time of the post-rotation is performed.

Accordingly, it is possible to reduce the number of times that the polarity of the applied voltage to the brush is switched for the removal of the primary collection toner at the time of the post-rotation, which can shorten the time period for the post-rotation.

### Embodiment 4

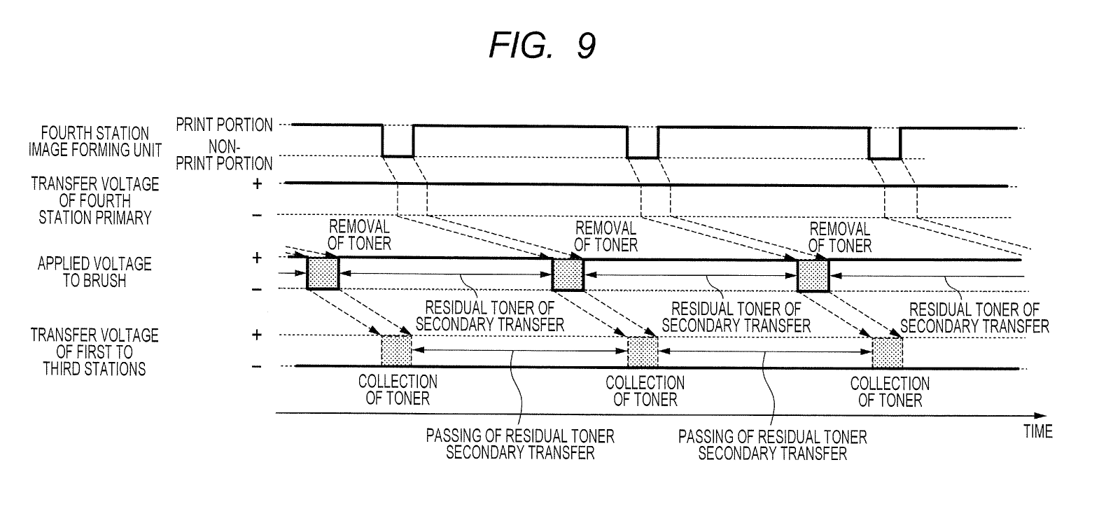

Next, Embodiment 4 of the present invention is described. Note that, an image forming apparatus applied in this embodiment has the same structure as that of Embodiment 1 described above, and the same components as those of Embodiment 1 are denoted by the same reference symbols, and descriptions thereof are omitted. Now, a sequence of this embodiment is described with reference to FIG. 9.

FIG. 9 is a timing chart illustrating brush cleaning and collection in the primary transfer portion according to this embodiment.

In this embodiment, the removal of the primary collection toner onto the interval between the residual toners of the secondary transfer and the collection of the discharged toner in the primary transfer portion that are performed during the continuous print job in a monochrome mode are described. Here, the monochrome mode is a mode in which the image formation is performed on the sheet by using any one of the photosensitive drums (first image bearing member) among the multiple photosensitive drums 1.

As illustrated in FIG. 9, in the monochrome mode, the image formation is performed only by the fourth station (black) 10d in a most downstream side in the moving direction of the surface of the intermediate transferring belt 6, and hence the primary transfer voltage of the fourth station 10d during the continuous printing is constantly set to the positive polarity. That is, the polarity of the primary transfer voltage of the fourth station 10d (voltage applied to the transfer member corresponding to the first image bearing member) is set to the same polarity as the polarity of the voltage applied when the toner image is primarily transferred onto the intermediate transferring belt 6 in a primary transfer portion N1d.

On the other hand, the primary transfer voltages of the first to third stations 10a to 10c are set to constantly have the negative polarity. That is, the polarity of the primary transfer voltages of the first to third stations 10a to 10c (voltages applied to the transfer members corresponding to the image bearing members except the first image bearing member) is set to the following polarity. That is, the polarity is the opposite polarity to the polarity of the voltage applied when the toner images are primarily transferred onto the intermediate transferring belt 6 in the primary transfer portions N1a to N1c, respectively.

After the image primarily transferred by the fourth station 10d is transferred onto the sheet in the secondary transfer portion N2, the primary collection toner is discharged onto the interval between the residual toners of the secondary transfer at a timing determined based on a detection result of the sheet trailing edge from the shutter member 18 described in Embodiment 2.

The discharged toner is charged to the negative polarity, and is therefore collected onto the photosensitive drums 1a to 1c with the negative-polarity applied voltages of the first to third stations 10a to 10c, respectively. On the other hand, the residual toner of the secondary transfer is charged to the positive polarity, and therefore passes through the first to third stations 10a to 10c to be transferred and simultaneously collected by the fourth station 10d to which the positive-polarity applied voltage is applied.

As described above, in this embodiment, even if the primary transfer has not been finished in the monochrome mode, without consideration of the overlapping area between the interval between the primary transfer images and the residual toner of the secondary transfer, the primary collection toner can be discharged onto each interval between the residual toners of the secondary transfer. Accordingly, as shown in FIG. 6, an effect equivalent to the effect of Embodiment 2 is obtained with regard to the cleaning defection.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-153591, filed Jul. 9, 2012, which is hereby incorporated by reference herein in its entirety.

What is claimed is:

1. An image forming apparatus, comprising:
an image bearing member for bearing a toner image;
an intermediate transferring member that has an endless shape and is rotatable, the intermediate transferring member configured to secondarily transfer the toner image primarily transferred from the image bearing member in a primary transfer portion, onto a recording material in a secondary transfer portion;
a brush member brought into contact with the intermediate transferring member at a position downstream of the secondary transfer portion in a rotational direction of the intermediate transferring member and upstream of the primary transfer portion, the brush member being configured to charge a residual toner remaining on the intermediate transferring member without being secondarily transferred onto the recording material in the secondary transfer portion to an opposite polarity to a normal charge polarity of a toner;
a power supply portion for applying a voltage to the brush member; and
a control device for controlling the power supply portion, the control device being capable of executing a cleaning mode for collecting, from the brush member, the residual toner adhering to the brush member;
wherein in a case where image formation is continuously performed for multiple recording materials, when the cleaning mode is executed, the control device moves the residual toner adhering to the brush member from the brush member to an area on the intermediate transferring member located between the residual toner remaining on the intermediate transferring member without being secondarily transferred onto a leading recording material and the residual toner remaining on the intermediate transferring member without being secondarily transferred onto a recording material following the leading recording material.

2. An image forming apparatus according to claim 1, wherein the control device moves the residual toner from the brush member by applying a voltage having the same polarity as the normal charge polarity of the toner from the power supply portion to the brush member.

3. An image forming apparatus according to claim 1, wherein the brush member comprises multiple conductive fibers, the multiple conductive fibers keeping contact with the intermediate transferring member that is under a rotational movement.

4. An image forming apparatus according to claim 1, further comprising a transfer member for primarily transferring the toner image onto the intermediate transferring member from the image bearing member through application of a voltage thereto,
wherein a voltage having the opposite polarity is applied to the transfer member when the residual toner charged to the opposite polarity by the brush member is moved from the intermediate transferring member to the image bearing member in the primary transfer portion; and
a voltage having the same polarity as the normal charge polarity is applied to the transfer member when the residual toner, which is moved from the brush member to the intermediate transferring member in execution of the cleaning mode, migrates from the intermediate transferring member to the image bearing member in the primary transfer portion.

5. An image forming apparatus according to claim 1, wherein a timing in which the area passes through the primary transfer portion is a timing after the toner image is primarily transferred onto the intermediate transferring member in order to perform the image formation for the leading recording material and before the toner image is primarily transferred onto the intermediate transferring member in order to perform the image formation for the following recording material, in the case where the image formation is continuously performed for the multiple recording materials.

6. An image forming apparatus according to claim 1, further comprising a detection device for detecting the recording material being conveyed to the secondary transfer portion,
T1, T2, T3 and T4 satisfy |T1−T2|<T3−T4,
wherein T1 represents a time period after the detection device detects the recording material until the primary transfer portion is reached by the toner image to be transferred onto a recording material following the recording material onto which the toner image, which is primarily transferred when the detection device detects the recording material, is transferred,
T2 represents a time period after the detection device detects the recording material until the primary transfer portion is reached by the residual toner remaining on the intermediate transferring member without being secondarily transferred onto the recording material following the detected recording material,
T3 represents a time period after a trailing edge of the leading recording material passes through the secondary transfer portion until the following recording material reaches the secondary transfer portion, and
T4 represents a time period required for one point on an outer peripheral surface of the intermediate transferring member to pass through a position opposed to the brush member.

7. An image forming apparatus according to claim 1, wherein the detection device comprises a swing member provided in a stand-by position so as to be swingable, for correcting skew feeding of the recording material by being brought into contact with the conveyed recording material and causing the recording material to pass through the swing member by moving from the stand-by position due to the contact with the recording material; and
the detection device detects the swing member returning to the stand-by position after the recording material has passed therethrough in order to detect a trailing edge of the recording material.

8. An image forming apparatus according to claim 1, wherein the control device executes the cleaning mode after the toner image used for performing the image formation for a last recording material among the multiple recording materials being continuously subjected to the image formation is primarily transferred onto the intermediate transferring member in the primary transfer portion.

9. An image forming apparatus according to claim 1, wherein n-th and (n+1)-th recording materials from a last recording material, Li, L1 and L2 satisfy
n(L1+L2)≦Li<(n+1)(L1+L2),
wherein n represents a natural number;
Li represents a length of an outer peripheral of the intermediate transferring member;
L1 represents a length of the recording material in the rotational direction; and
L2 represents a length of movement of one point on an outer peripheral surface of the intermediate transferring member after a trailing edge of the leading recording material passes through the secondary transfer portion until the following recording material reaches the secondary transfer portion.

10. An image forming apparatus according to claim 1, further comprising multiple other image bearing members provided on a downstream side of the image bearing member in the rotational direction of the intermediate transferring member.

11. An image forming apparatus according to claim 1, wherein the residual toner charged by the brush member is caused to migrate from the intermediate transferring member to the image bearing member at the same timing as a timing at which the toner image is primarily transferred onto the intermediate transferring member from the image bearing member in the primary transfer portion.

12. An image forming apparatus according to claim 1, wherein the brush member and the intermediate transferring member have a contact width therebetween, which is smaller than a width of the area, in the rotational direction of the intermediate transferring member.
